(19) United States
(12) Patent Application Publication
(10) Pub. No.: US 2014/0030622 A1
(43) Pub. Date: Jan. 30, 2014

(54) CONTROL METHOD OF REPLENISHING ANODE FUEL FOR DMFC SYSTEM

(71) Applicant: INDUSTRIAL TECHNOLOGY RESEARCH INSTITUTE, Hsinchu (TW)

(72) Inventors: Ching-Jung Liu, Hsinchu County (TW); Ku-Yen Kang, Hsinchu City (TW); Chun-Ho Tai, Hsinchu City (TW); Chung-Jen Chou, Yunlin County (TW); Shou-Hung Ling, Taipei City (TW)

(73) Assignee: INDUSTRIAL TECHNOLOGY RESEARCH INSTITUTE, Hsinchu (TW)

(21) Appl. No.: 13/706,359

(22) Filed: Dec. 6, 2012

(30) Foreign Application Priority Data
Jul. 26, 2012 (TW) 101127065

(51) Int. Cl. H01M 8/04

(52) U.S. Cl. CPC H01M 8/04753; H01M 8/0432; H01M 8/04574; H01M 8/04992
USPC 429/431

(57) ABSTRACT

A control method of replenishing anode fuel for DMFC system is provided. The DMFC system includes at least a fuel cell, a cathode humidity-holding layer, a fuel distribution unit, a control unit, a liquid fuel replenishment device, a fuel storage region, and a temperature detecting device. The temperature detecting device is for detecting an actual temperature of the fuel cell. The control method of replenishing anode fuel includes utilizing the control unit to adjust a fuel replenishment amount supplied from the liquid fuel replenishment device. The fuel replenishment amount is the sum of a basic replenishment amount and a replenishment amount for temperature correction. The basic replenishment amount is a function of actual discharge current of the fuel cell. The replenishment amount for temperature correction is a function of the difference between the actual temperature of the fuel cell and the target temperature.

### CROSS-REFERENCE TO RELATED APPLICATION

This application claims the priority benefit of Taiwan application serial no. 101127065, filed on Jul. 26, 2012. The entirety of the above-mentioned patent application is hereby incorporated by reference herein and made a part of this specification.

### TECHNICAL FIELD

The technical field relates to a control method of replenishing anode fuel for direct methanol fuel cell (DMFC) system.

### BACKGROUND

The reaction formula of DMFC is as follows.

Anode: CH₃OH+H₂O→CO₂+6H⁺+6e⁻

Cathode: 3/2 O₂+6H⁺+6e⁻→3H₂O

During reaction, methanol and water in the anode must be kept in a suitable concentration. In theory, the concentration ratio of methanol to water is 1 mole: 1 mole However, since the electrolyte layer can't prevent high concentration methanol aqueous solution from crossing over to the cathode, in the conventional fuel cell system, the cathode water is collected by the cathode with a condenser, and then the collected cathode water is transferred back to the fuel mixing tank on the anode side with a fuel concentration detector, a fuel cycle pump, a high concentration methanol replenishment pump, etc. so as to control the concentration of methanol aqueous solution in the anode region.

In the recent years, the passive backwater method of cathode has been developed. The above-described method makes a difference of the concentration gradient of wafer between the anode and the cathode by controlling the moisture of the cathode, and thus the cathode water is recycled by penetrating back to the anode through the electrolyte film. In this type of fuel cell system, there is no need of recycling water device on the cathode side such as condenser and so on, and there is also no need of complicated device on the anode side such as mixing tank. A micro pump is only required to timely supply high concentration methanol to the anode side with suitable amount. However, if methanol fuel cannot supply with suitable amount timely, the operation stability of the fuel cell system would be affected.

### SUMMARY

One of exemplary embodiments comprises a control method of replenishing anode fuel for DMFC system. The DMFC system includes at least a fuel cell, a cathode humidity-holding layer disposed on the cathode side of the fuel cell, a fuel distribution unit disposed on the anode side of the fuel cell, a control unit, a liquid fuel replenishment device, a fuel storage region, and a temperature detecting device, wherein the fuel replenishment device is controlled by the control unit to transfer a methanol fuel in the fuel storage region to the fuel distribution unit and further distribute the methanol fuel over the fuel cell, and the temperature detecting device is for detecting an actual temperature of the fuel cell. The control method of replenishing anode fuel comprises utilizing the control unit to adjust a fuel replenishment amount supplied from the liquid fuel replenishment device. The fuel replenishment amount is a sum of a basic replenishment amount and a replenishment amount for temperature correction. The basic replenishment amount is a function of actual discharge current of the fuel cell. The replenishment amount for temperature correction is a function of the difference between the actual temperature of the fuel cell and a target temperature.

Several exemplary embodiments accompanied with figures are described in detail below to further describe the disclosure in detail.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1A is a schematic block diagram illustrating the fuel cell system according to an exemplary embodiment.

FIG. 1B is a schematic block diagram of another example of the fuel cell system according to the exemplary embodiment.

FIG. 2 is a schematically sectional view illustrating the fuel cell set of another exemplary embodiment.

FIG. 3 is a graph illustrating the curve of the replenishing anode fuel control performed according to a basic replenishment amount for the fuel cell system of FIG. 1.

FIG. 4 is a graph illustrating the curve of the predetermined replenishment amount and the difference (Tc-Tg).

FIG. 5 is a graph illustrating the curve of the variation slope of actual temperature and the difference (Tc-Tg).

FIG. 6A shows the actual testing result according to the experimental example 1 with the method as provided by WO 2010013711.

FIG. 6B shows the actual testing result according to the experimental example 1 with the control method of replenishing anode fuel of the disclosure.

FIG. 7 shows the actual testing result according to the experimental example 2 under the variations in ambient temperature and target temperature.

FIG. 8A shows the actual testing result according to the experimental example 3 under low ambient temperature.

FIG. 8B is the actually testing result according to the experimental example 4 under high ambient temperature.

### DETAILED DESCRIPTION OF DISCLOSED EMBODIMENTS

One of exemplary embodiments comprises a control method of replenishing anode fuel for DMFC system.

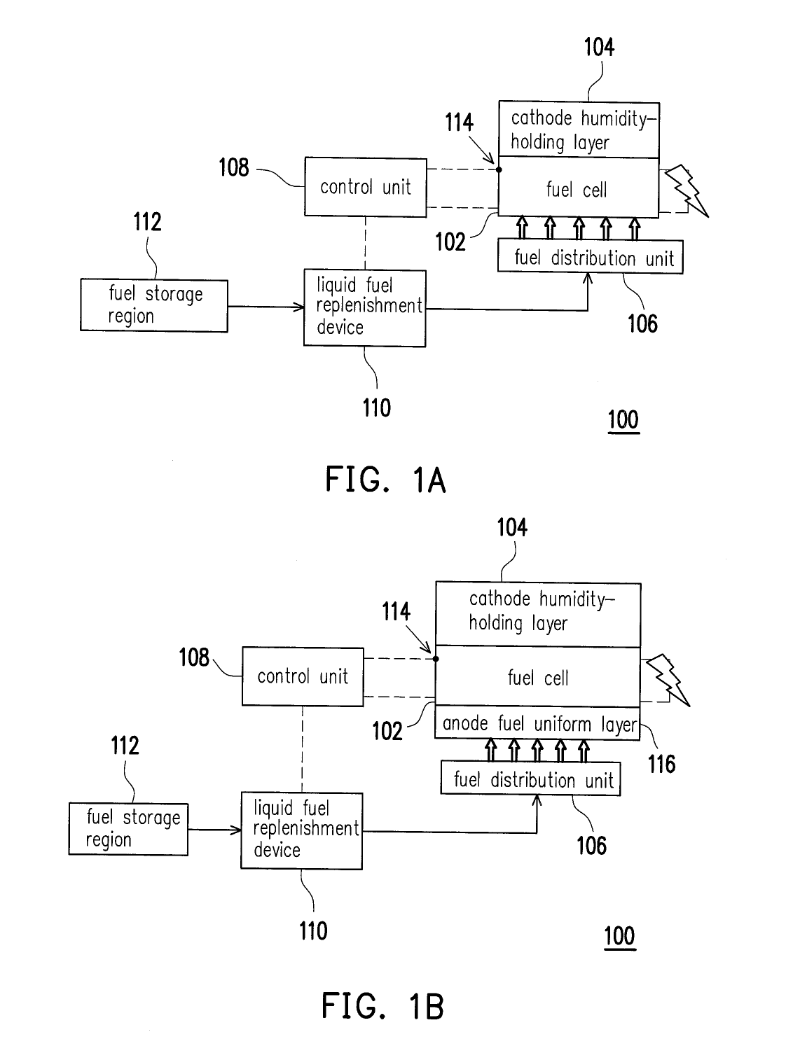

FIG. 1A is a schematic block diagram of the fuel cell system according to the exemplary embodiment. Referring to FIG. 1A, a fuel system 100 at least includes a fuel cell 102, a cathode humidity-holding layer 104 disposed on the cathode side of the fuel cell 102, a fuel distribution unit 106 disposed on the anode side of the fuel cell 102, a control unit 108, a liquid fuel replenishment device 110, a fuel storage region 112, and a temperature detecting device 114. The liquid fuel replenishment device 110 can be controlled by the control unit 108 to transfer an methanol fuel in the fuel storage region 112 to the fuel distribution unit 106. The methanol fuel is distributed over the fuel cell 102 through an internal channel of the fuel distribution unit 106. The temperature detecting device 114 is used to measure an actual temperature of the fuel cell 102, wherein the actual temperature is provided to the control unit 108 for subsequently controlling how to replenishing anode fuel.

The cathode humidity-holding layer 104 is used to control the evaporation rate of the water produced from a cathode of the fuel cell 102 after reaction, whereby diffusing the water from the cathode region to the anode region through a proton conduction membrane for supplying the anode reaction of the fuel cell 102. The cathode humidity-holding layer 104 may be a gas-barrier material, such as a metal, a ceramics, a polymer, and so on. If the permeability of the cathode humidity-holding layer 104 could be remained appropriately, the cathode humidity-holding layer 104 may appropriately control the rate of releasing/saving the cathode water vapor and allow the oxygen gas desired by the cathode reaction of the fuel cell 102 entering therein. For example, the permeability of the cathode humidity-holding layer 104 is determined by a porous opening ratio. In this exemplary embodiment, the porous opening ratio may be between 0.5% and 21%, and for example, the porous opening ratio of the cathode humidity-holding layer 104 may be about 5%. The cathode humidity-holding layer 104, for example, has a thickness between 10 μm and 5 mm; in this exemplary embodiment, the thickness may be about 200 μm.

Before detailed description about the control method, the fuel cell system of this exemplary embodiment may have another example, as shown in FIG. 1B. In FIG. 1B, an anode fuel uniform layer 116 may be disposed between the fuel cell 102 and the fuel distribution unit 106 such that the methanol fuel transferred by the fuel distribution unit 106 can be dispersed uniformly through the anode fuel uniform layer 116 further. For example, the anode fuel uniform layer 116 has a fuel-philic property. That is, the contact angle between the anode fuel uniform layer 116 and the methanol fuel is less than 90 degrees. The so-called “fuel-philic” is not equal to the “hydrophilic” due to some material may have a contact angle less than 90 degrees with methanol but have another contact angle larger than 90 degrees with water. The anode fuel uniform layer 116 may be a fuel-philic material, such as a non-woven fiber, a woven fiber, a paper, a foam, a polymer, or the like thereof. In addition, the anode fuel uniform layer 116 may be optionally added into the fuel distribution unit 106 to disperse the methanol fuel uniformly.

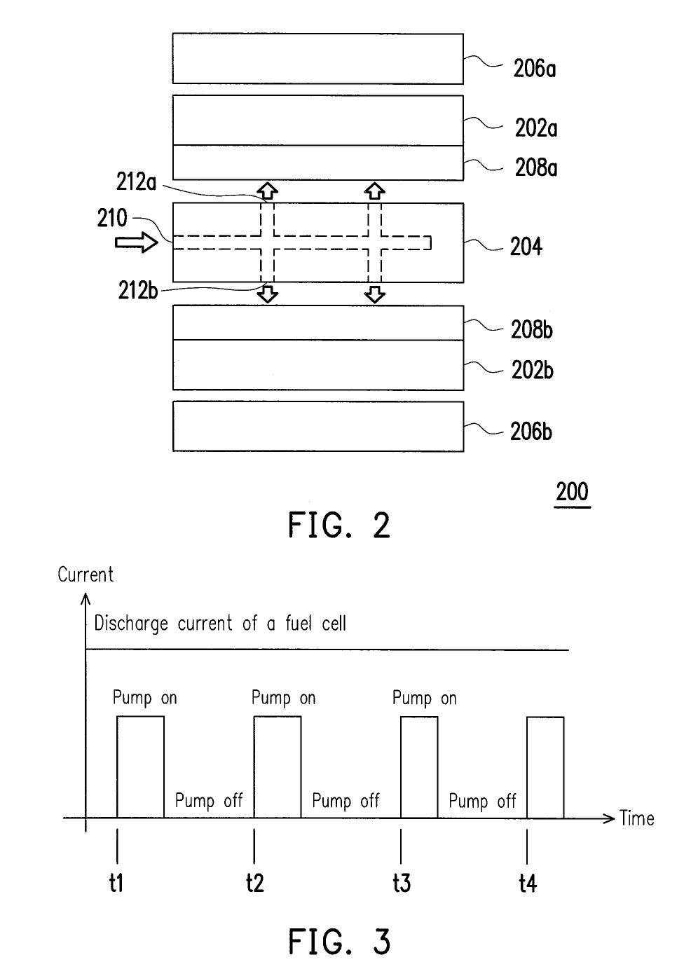

The methanol fuels in FIG. 1A and FIG. 1B are both transferred to the fuel cell 102 by the fuel distribution units 106 unidirectionally, but the exemplary embodiment is not limited thereto. The structure constituted by the fuel cell 102, the cathode humidity-holding layer 104, the fuel distribution unit 106, and the anode fuel uniform layer 116 may be replaced with the structure as shown in FIG. 2.

FIG. 2 is a schematically sectional view illustrating a fuel cell set of another exemplary embodiment. In FIG. 2, a fuel cell set 200 includes at least fuel cells 202a˜b, a fuel distribution unit 204, cathode humidity-holding layers 206a˜b, and anode fuel uniform layers 208a˜b, wherein the fuel distribution unit 204 is used as transferring an anode fuel to the fuel cells 202a˜b disposed on its upper and lower sides. There are at least one entry 210 and at least two exits 212a˜b in the fuel distribution unit 204 to receive and then transfer the methanol fuel to the fuel cells 202a˜b, respectively. The dashed lines in FIG. 2 show the channels in the fuel distribution unit 204, and the channels may be filled with filling materials, such as capillaries or other suitable materials. For example, the filling material of which contact angle with the methanol fuel is less than 90 degrees is utilized. That is, the filling materials have the fuel-philic property.

The associated components in FIG. 1B may be replaced by the fuel cell set 200 in FIG. 2, and if the fuel could be distributed by the fuel distribution unit 204 itself, the anode fuel uniform layer 208a˜b may be omitted.

Whether the fuel cell system of FIG. 1A or FIG. 1B, or the fuel cell set of FIG. 2 was utilized, the control method of replenishing anode fuel for a DMFC system of the disclosure is adopted. The control method of replenishing anode fuel for the DMFC system will be described in detail as below that the control unit 108 is used to adjust with a fuel replenishment amount, which is provided by the liquid fuel replenishment device 110.

The fuel replenishment amount described in the disclosure is a sum of a basic replenishment amount and a replenishment amount for temperature correction.

The basic replenishment amount is a function of actual discharge current of the fuel cell, and it can be the demand amount of fuel represented by the following formula (1), which is calculated by the integration of the discharge current during periods of time.

$$Basic replenishment amount = cl \times {\int }_{t ( n )}^{t ( n + 1 )} ( Discharge current of the fuel cell ) d t \qquad ( 1 )$$

In formula (1), c1 is a constant determined by the area of the membrane electrode assembly (MEA) and the pieces in series. In general, the larger the area of MEA or the more pieces in series, the bigger the value of c1. In addition, n represents a period number of time, wherein n≧0.

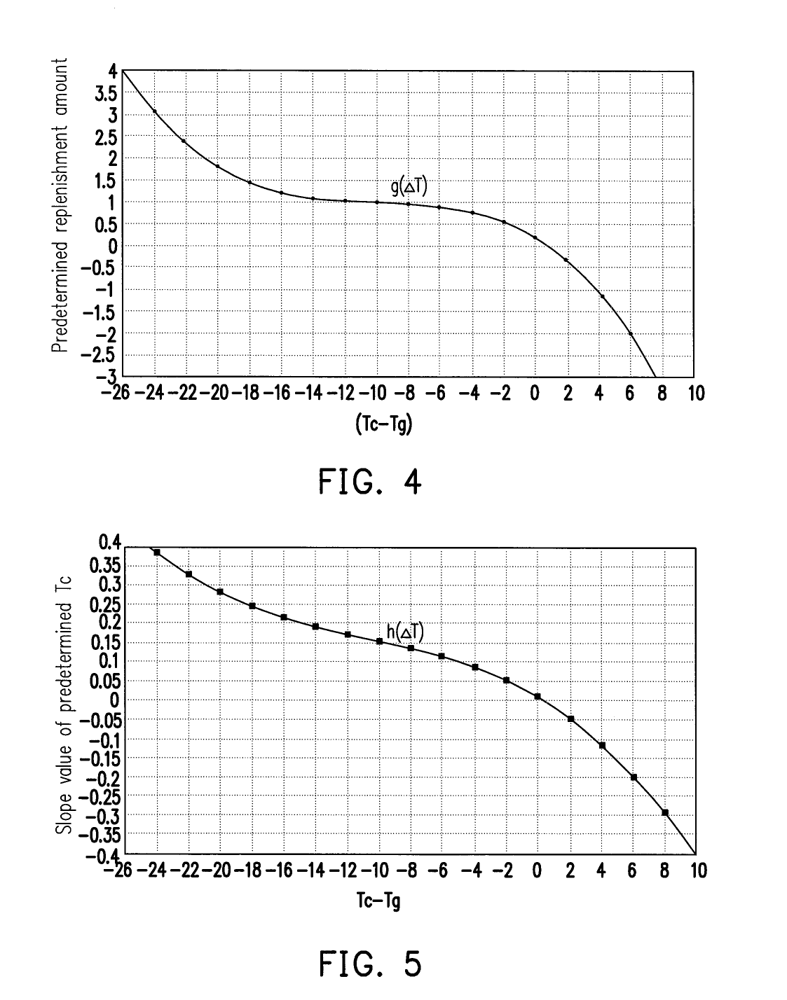

When the fuel cell system of FIG. 1 is subjected to the replenishing anode fuel control with the basic replenishment amount, a graph schematically illustrating a fuel replenishment can be obtained in FIG. 3. FIG. 3 only schematically shows the part of the replenishment amount without the replenishment amount for temperature correction.

The replenishment amount for temperature correction is a function of the difference between an actual temperature and a target temperature of the fuel cell. The output power is too low when an operation temperature of the fuel cell is low, while the fuel may be wasted too much when the temperature is high resulting in internal resistance out of control. Thus, in order to operate the fuel cell stably, a target operation temperature of the fuel cell system, which can be a constant or can be a variation with an ambient temperature, may be set in a general function. The actual temperature (Tc) of the fuel cell is controlled to be close to the desired target temperature (Tg) by the replenishment amount for temperature correction.

The replenishment amount for temperature correction of the fuel replenishment amount described in the disclosure is represented by the following formula (2):

Replenishment amount for temperature correction=c2×g(ΔT) (2)

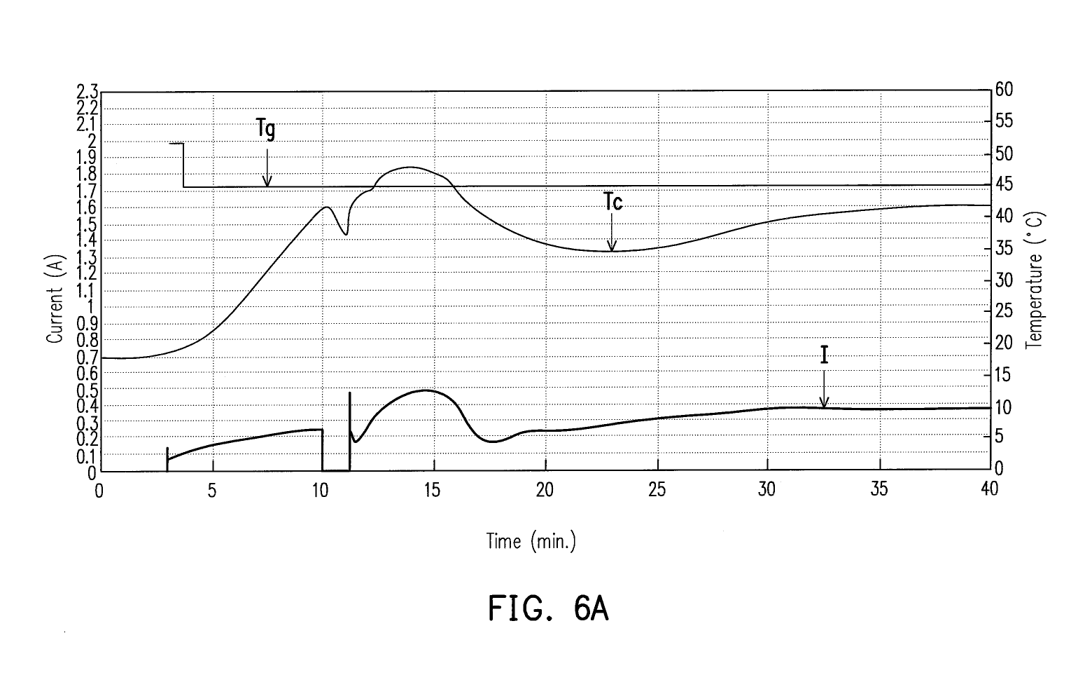

In formula (2), c2 is a constant determined by the actual needs of the system, and g(ΔT) is a predetermined replenishment amount. Referring to the curve (i.e. the predetermined replenishment amount) in FIG. 4, the predetermined replenishment amount of the replenishment timing can be determined by the control unit 108 depending on the value of the horizontal axis (Tc-Tg). The predetermined replenishment amount g(ΔT) and the difference (Tc-Tg) are in a non-linear inverse ratio, and the g(ΔT) can be represented by a nth-degree polynomial function of the (Tc-Tg), wherein n≧3. In such design of the predetermined replenishment amount, the temperature can be increased fast when the actual temperature Tc of the fuel cell is too low, the Tc can be controlled for closing to the target temperature gradually; and when the Tc is too high, the predetermined replenishment amount can be reduced to drop the Tc. Thus, the replenishment amount for temperature correction and the difference (Tc-Tg) are also in a non-linear inverse ratio and represented by a nth-degree polynomial function of the difference, wherein the n≧3. In addition, in order to prevent the replenishment amount of the methanol fuel from being too much or too less, it is optionally to preset the upper limit and/or the lower limit of the replenishment amount for temperature correction.

Because the fuel replenishment amount described in the disclosure has not only the above-described replenishment amount for temperature correction but the basic replenishment amount, the replenishment amount for temperature correction may be negative. The basic replenishment amount can also reduce the vibrations of temperature and output power caused by the replenishment amount for temperature correction. The fuel cell can be operated stably with the cooperation of the replenishment amount for temperature correction and the basic replenishment amount.

In addition to the control method described above, the replenishment amount for temperature correction may be adjusted by considering a variation slope of the actual temperature of the fuel cell. In other words, a function of the variation slope of the actual temperature of the fuel cell may be added to the replenishment amount for temperature correction in order to prevent the actual temperature (Tc) of the fuel cell from being increased too fast or too slow.

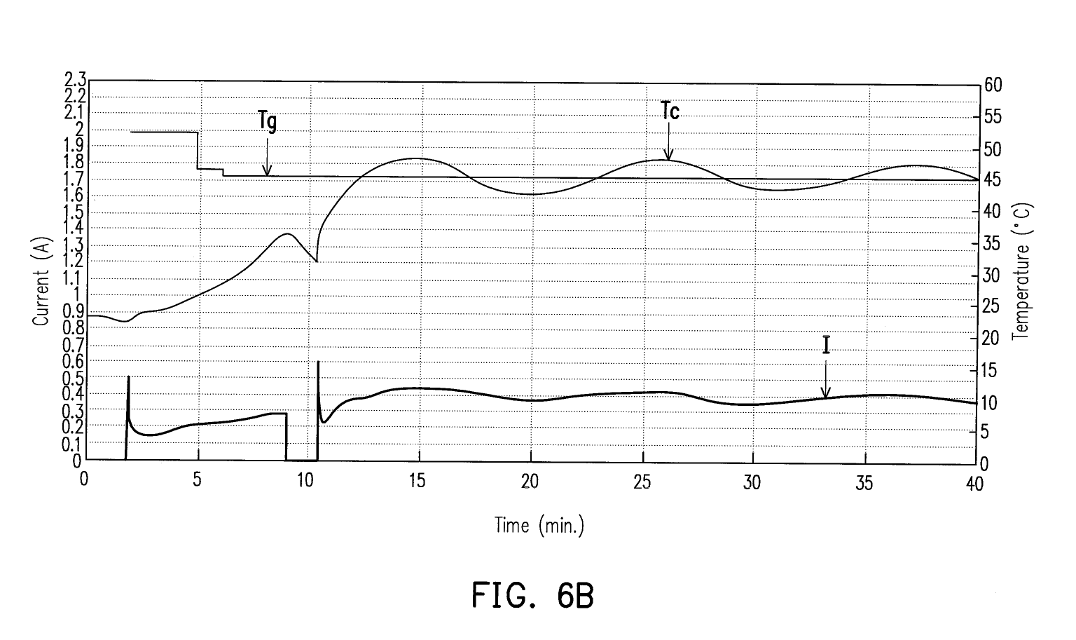

As shown in FIG. 5, the vertical axis is a variation slope of the predetermined Tc, and the curve h(ΔT) is a slope of the predetermined Tc, which is the increasing rate or the decreasing rate of the predetermined Tc under the temperature condition of (Tc-Tg). The control unit 108 is used to measure the variation slope of the actual temperature during a period of time (i.e. dTc/dt) and calculate the value of (the slope of the predetermined Tc—the slope of the actual Tc), which is [h(ΔT)-(dTc/dt)] at the right side in the following formula (3), and the replenishment amount for temperature correction is adjusted through this calculated value.

The replenishment amount for temperature correction of the fuel replenishment is represented by the following formula (3):

$$Replenishment amount for temperature correction = c 2 \times \{ g ( Δ T ) + c 3 \times [ h ( Δ T ) - ( \frac{d Tc}{d t} ) ] \} \qquad ( 3 )$$

In formula (3), c2 and g(ΔT) are as described in above formula (2); h(ΔT) is the variation slope of the predetermined Tc; dTc/dt is the variation slope of the actual Tc; and c3 is a constant.

The performances of the disclosure will be described in detail with reference to the following experimental examples. It notes that the data of each experimental example is only used to describe the testing result of the control method provided by the disclosure but not tend to limit the scope of the disclosure.

### Experimental Example 1

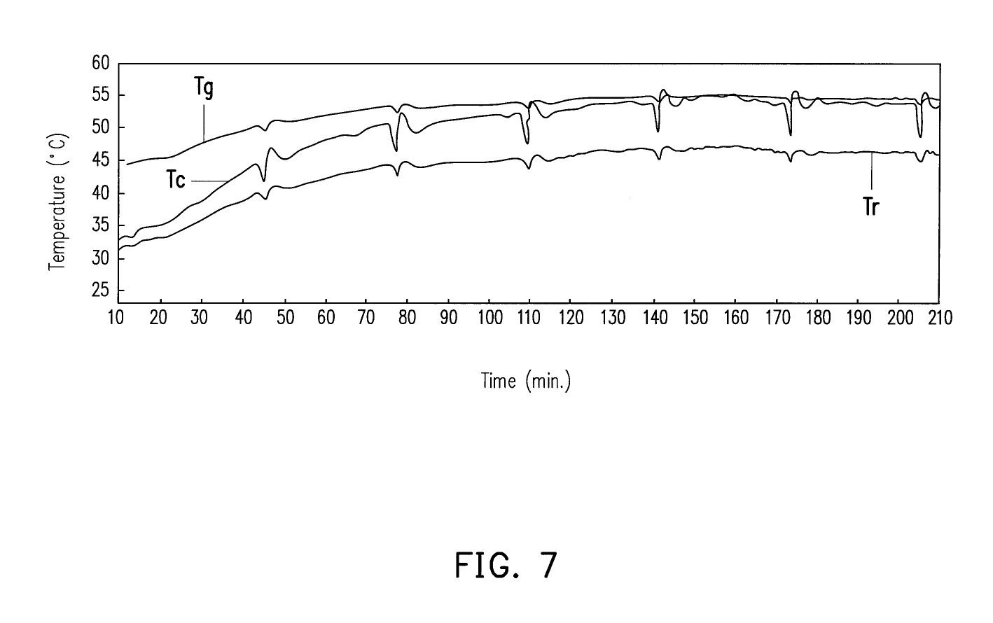

FIG. 6A and FIG. 6B show the actual testing results of the constant voltages output by the fuel cell. FIG. 6A shows the actual testing result with the method as provided by WO 2010013711. FIG. 6B shows the performance of using the control method for replenishing anode fuel of the disclosure, which containing the basic replenishment amount and the replenishment amount for temperature correction together.

As the results are illustrated in FIG. 6A and 6B, it can be seen that the vibration ranges of the temperature (Tc) and the current (I) are more convergent according to the method of the disclosure.

### Experimental Example 2

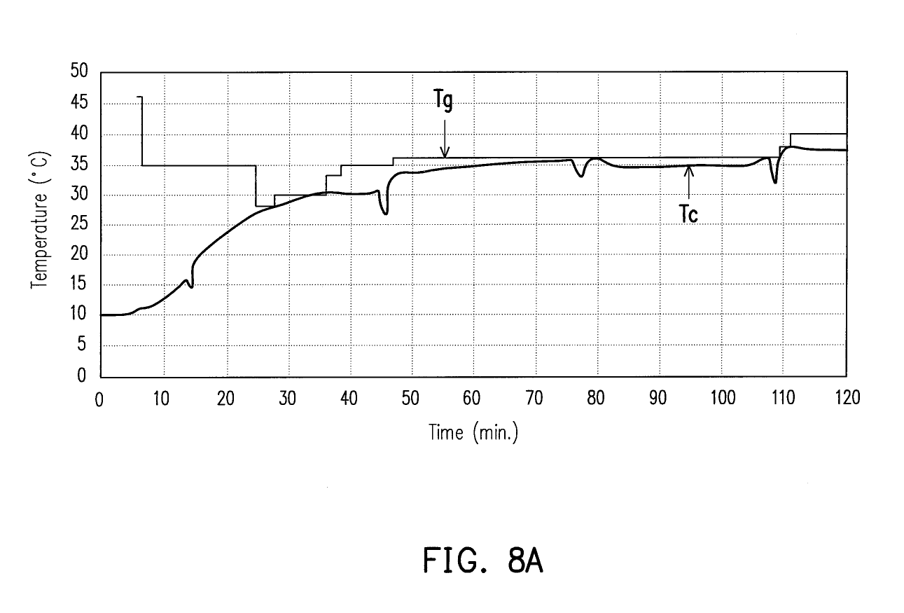

Except for the changes of the ambient temperature (Tr) and the target temperature (Tg), the method is the same as previous experimental example shown in FIG. 6B. The testing result of experimental example 2 is shown in FIG. 7.

As the results are illustrated in FIG. 7, it can be seen that the method of the disclosure is capable of stabilizing the actual temperature (Tc) of the fuel cell, even through the fuel cell is under the variations of the ambient temperature (Tr) and the target temperature (Tg).

### Experimental Example 3

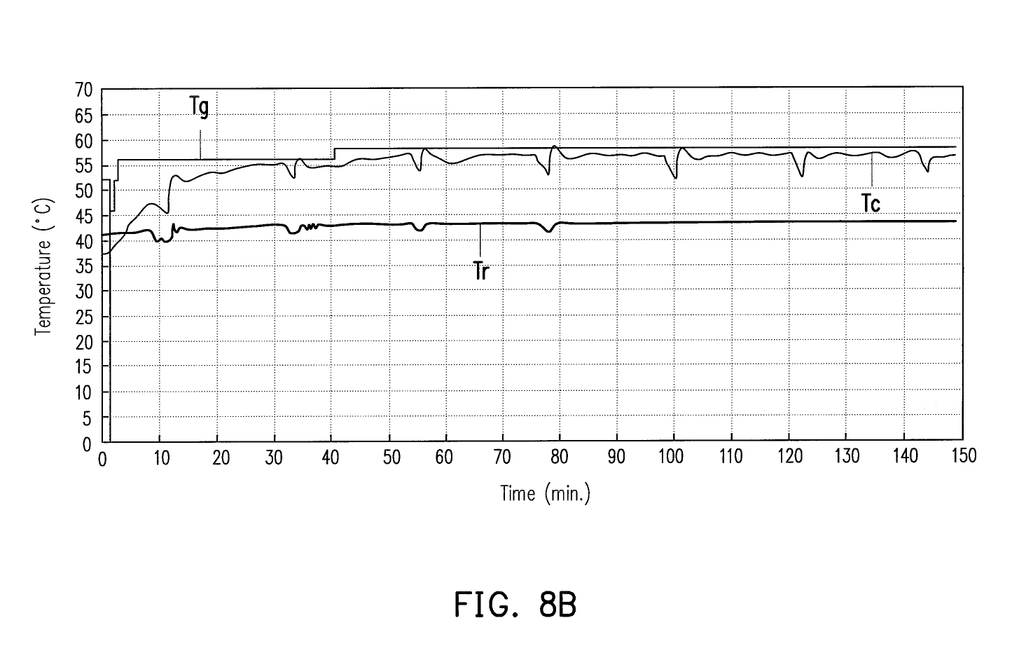

Referring to FIG. 8A, experimental example 3 shows the actual testing result under low ambient temperature (about 10° C.). From the FIG. 8A, it is known that the method of the disclosure is capable of stabilizing the actual temperature (Tc) of the fuel cell, even through the fuel cell is under low ambient temperature.

### Experimental Example 4

Referring to FIG. 8B, experimental example 4 shows the actual testing result under the ambient temperature (Tr) of about 43° C. From FIG. 8B, it is known that the method of the disclosure is capable of stabilizing the actual temperature (Tc) of the fuel cell in the similar way, even through the fuel cell is under high ambient temperature.

As described above, in the control method of replenishing anode fuel for

DMFC system of the disclosure, a function of actual discharge current of a fuel cell, referred as the basic replenishment amount, is taken into consideration when a fuel replenishment amount is calculated, so as to reduce the temperature vibration and the output power vibration caused by the replenishment amount for temperature correction, whereby stabilizing the operation of DMFC system.

It will be apparent to those skilled in the art that various modifications and variations can be made to the structure of the disclosed embodiments without departing from the scope or spirit of the disclosure. In view of the foregoing, it is intended that the disclosure cover modifications and variations of the disclosure provided they fall within the scope of the following claims and their equivalents.

What is claimed is:

1. A control method of replenishing anode fuel for a DMFC system, the DMFC system includes at least a fuel cell, a cathode humidity-holding layer disposed on a cathode side of the fuel cell, a fuel distribution unit disposed on an anode side of the fuel cell, a control unit, a liquid fuel replenishment device, a fuel storage region, and a temperature detecting device, wherein the fuel replenishment device is controlled by the control unit to transfer a methanol fuel in the fuel storage region to the fuel distribution unit and further distribute the methanol fuel over the fuel cell, and the temperature detecting device is for detecting an actual temperature of the fuel cell, wherein the control method of replenishing anode fuel comprising:
utilizing the control unit to adjust a fuel replenishment amount supplied from the liquid fuel replenishment device, the fuel replenishment amount is a sum of a basic replenishment amount and a replenishment amount for temperature correction, wherein
the basic replenishment amount is a function of actual discharge current of the fuel cell; and
the replenishment amount for temperature correction is a function of a difference between the actual temperature of the fuel cell and a target temperature.

2. The control method of replenishing anode fuel for the DMFC system of claim 1, wherein the replenishment amount for temperature correction and the difference are in a non-linear inverse ratio and represented by a nth-degree polynomial function of the difference, wherein n≧3.

3. The control method of replenishing anode fuel for the DMFC system of claim 1, wherein the replenishment amount for temperature correction further comprises a function of a variation slope of the actual temperature.

4. The control method of replenishing anode fuel for the DMFC system of claim 1, further comprising: disposing an anode fuel uniform layer between the fuel cell and the fuel distribution unit to distribute the methanol fuel uniformly.

5. The control method of replenishing anode fuel for the DMFC system of claim 1, wherein the fuel distribution unit at least has an entry for accepting the methanol fuel and at least has two outlets for transferring the methanol fuel to the fuel cell.

6. The control method of replenishing anode fuel for the DMFC system of claim 1, wherein a material of the cathode humidity-holding layer comprises metals, ceramics or polymers, and a permeability of the cathode humidity-holding layer is determined by a porous opening ratio of the cathode humidity-holding layer.

7. The control method of replenishing anode fuel for the DMFC system of claim 6, wherein the porous opening ratio of the cathode humidity-holding layer is between 0.5% and 21%.

8. The control method of replenishing anode fuel for the DMFC system of claim 1, further comprising: presetting an upper limit value of the replenishment amount for temperature correction.

9. The control method of replenishing anode fuel for the DMFC system of claim 1, further comprising: presetting a lower limit value of the replenishment amount for temperature correction.
